(19) United States
(12) Patent Application Publication
(10) Pub. No.: US 2015/0081416 A1
(43) Pub. Date: Mar. 19, 2015

(54) Merchandise Kiosk and Web-Store System and Method

(71) Applicant: Richard Allen Ringo, Weatherford, TX (US)

(72) Inventor: Richard Allen Ringo, Weatherford, TX (US)

(21) Appl. No.: 14/458,727

(22) Filed: Aug. 13, 2014

Related U.S. Application Data
(60) Provisional application No. 61/866,153, filed on Aug. 15, 2013.

(51) Int. Cl. G06Q 30/06; G06Q 30/02

(52) U.S. Cl. CPC G06Q 30/0641; G06Q 30/0237; G06Q 30/0623; G06Q 30/0268; G06Q 30/0238
USPC 705/14.37; 705/26.61; 705/14.65; 705/16

(57) ABSTRACT

A method of selling products includes displaying web-store information related to a web-store on a consumer-operated kiosk at a location. The method may further include displaying product information with the web-store, in which the product information corresponds to products related to the location of the consumer-operated kiosk and available for purchase by a consumer from the web-store.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

As an example industry, since its inception, the movie industry has been a far reaching and extremely popular entertainment option world-wide. Thousands of movies have been released that have spawned a “cult following” of fans. With the short duration movies are in any given theater, it may not be feasible to offer point-of-sale merchandise at the theater or the location of the movie itself. As such, in the movie industry, as well as other industries such as that of music or sports, it may be beneficial to be able to offer merchandise, as well as other types of media and products, to consumers where the demand for the merchandise, media, and other products would be highest.

### BRIEF DESCRIPTION OF THE DRAWINGS

For a detailed description of the preferred embodiments of the present disclosure, reference will now be made to the accompanying drawings in which:

FIG. 1 shows a flow chart of one or more methods in accordance with one or more embodiments of the present disclosure; and

FIG. 2 shows a representative view of a system to sell products in accordance with one or more embodiments of the present disclosure.

### DETAILED DESCRIPTION

The following discussion is directed to various embodiments of the present disclosure. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but are the same structure or function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

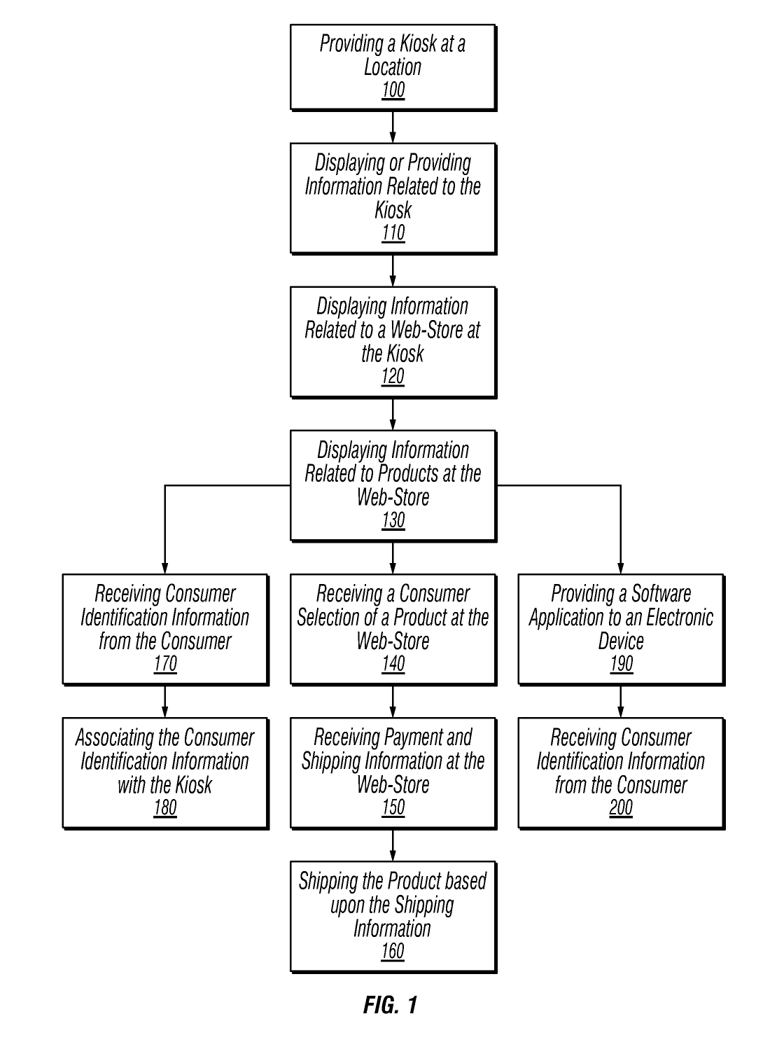

Referring now to FIG. 1, a flow chart of one or more methods in accordance with one or more embodiments of the present disclosure is shown. The flow chart shows multiple steps that may be included within a method of the present disclosure. One having ordinary skill in the art will appreciate that one or more steps shown within the FIG. 1 may be excluded from a method in accordance with the present disclosure, and will also appreciate that one or more steps not shown within FIG. 1 may also be included within a method in accordance with the present disclosure. Further, though the steps are shown in a potential order within FIG. 1, the present disclosure is not so limited, as other methods are contemplated that may be included within the scope of the present disclosure.

In FIG. 1, a method in accordance with the present disclosure may include providing a kiosk at a location 100. The kiosk may be a consumer-operated kiosk such that information provided at the kiosk may be navigated by the consumer. As such, the kiosk may be interactive, such as electronic and/or include a user interface. Additionally or alternatively, the kiosk may not be interactive or electronic such that the kiosk provides information to the consumer, such as through a display or paper format. The kiosk may also be provided at a location, such as an event of interest, or a viewing of an event of interest.

For example, with respect to the movie industry, the kiosk may be provided at a location of a movie theatre, or at a chain of movie theatres. In the music industry, the kiosk may be provided at a location of a concert event or a concert venue, or a viewing of the concert event, either live or re-broadcast, that may be separate from the location of the concert event. In the sports industry, the kiosk may be provided at a location of a sports event or a sports venue, or a viewing of the sports event, either live or re-broadcast, that may be separate from the location of the sports event. Those having ordinary skill in the art will also appreciate that other industries and other locations may be used and represented without departing from the scope of the present disclosure.

A method in accordance with the present disclosure may additionally or alternatively include displaying or providing information related to the kiosk 110. For example, consumer-operated kiosk information related to the kiosk, such as information on the presence of the kiosk, the location of the kiosk, or information available at or through the kiosk, may be displayed or provided to potential consumers. This may involve advertising or publicly displaying at the location information related to the kiosk and/or displaying information related to the kiosk location, such as a larger display for potential consumers to view and/or providing individual information packets or sheets to potential consumers. In one embodiment, as web-store information may be displayed at the kiosk, web-store information may be displayed at the location of the kiosk.

A method in accordance with the present disclosure may additionally or alternatively include displaying information related to a web-store at the kiosk 120. For example, web-store information related to the web-store, such as information on the presence of the web-store, the location of the web-store, or information available at or through the web-store (e.g., products available through the web-store), may be displayed or provided to potential consumers at the consumer-operated kiosk. This may involve interacting with the kiosk such that the kiosk directs a consumer to the web-store, and/or displaying or providing information to the consumer about accessing the web-store.

Further, a method in accordance with the present disclosure may additionally or alternatively include displaying information related to products at the web-store 130. Product information may be displayed or provided at the web-store through one or more different mediums or channels, such as through a website and/or a software application. The product information may then correspond to products that are related to the location of the kiosk and/or available for purchase by the consumer at the web-store (e.g., a point-of-sale at the web-store). For example, with respect to the movie industry, the web-store may display or provide products that are related to the movie industry, as the kiosk may be positioned within a location of a movie theatre. With respect to other industries, the web-store may then display or provide products that are related to the location of the kiosk for the respective industry.

In one or more embodiments, if a consumer has decided to purchase a product, a method of the present disclosure may further include receiving a consumer selection of the product, such as at the web-store 140. Payment information related to the selected product and shipping information for the product or consumer (e.g., address for delivery of the product) may also be received at the web-store 150, thereby enabling the selected product to be shipped based upon the shipping information received 160. In one or more embodiments, merchandise inventory may not be stored or stocked at the location of the kiosk, as this may be a benefit of providing a kiosk at a location with higher turnover of events. Accordingly, the selected product is not shipped from the location of the consumer-operated kiosk, and instead may be shipped from a location use to centrally stock the products for later sale.

Referring still to FIG. 1, a method in accordance with the present disclosure may additionally or alternatively include receiving consumer identification information related the consumer 170. For example, information that may be used to identify and/or be correlated with the consumer may be received through the kiosk and/or through the web-store. This may involve a consumer actively providing identifying information, such as the consumer interacting with the kiosk and/or web-store, and/or may involve identifying information that may be passively drawn or received from the consumer. Further, the consumer identification information may also be stored, such as within a database. This may enable the information to be sortable and/or retrieved for later use and access, such as for distributing information related to other kiosks, web-stores, product information, in addition to other options. In one embodiment, a method may involve associating the consumer identification information with the kiosk 180, such as associating the consumer with the location of the kiosk. In an embodiment with respect to the movie industry, this may involve associating the consumer with a location of a movie theatre, may involve associating the consumer with a particular movie, and/or associating the consumer with a particular date and/or time of the movie.

A method in accordance with the present disclosure may additionally or alternatively include providing a software application to an electronic device 190. For example, an electronic device may include a personal computer, a mobile device, and/or any other type of device that may be able to access or support the internet, the web-store, and/or the software application (e.g., phone app). The web-store, web-store information, kiosk information, production information, and/or consumer identification information may be accessible by a consumer through the software application. Further, consumer identification information may be received from the consumer 200 through or using the software application.

In one or more embodiments, a reminder or a notification may be sent to the consumer, the software application, the electronic device, the web-store, and/or the kiosk. For example, a reminder may be sent to a consumer, such as web-store information or product information sent to an electronic device, an electronic address, and/or a physical address associated with the consumer. Additionally or alternatively, a notification may be sent to the software application, such as a notification that includes information related to the web-store and/or a location of a consumer-operated kiosk. For instance, when an electronic device is within a predetermined area or distance of a consumer-operated kiosk, a notification may be sent to the software application to notify the consumer of the consumer-operated kiosk.

Further, in one or more embodiments, consumer identification information may be associated with a discount for the consumer, in which this discount may be transmitted to a point-of-sale at the web-store and applied to a price of product. A method in accordance with the present disclosure may additionally or alternatively include providing or displaying promotional information, such as to a consumer, related to a promotion available at a location, at the kiosk, at the web-store, and/or at the software application. For example, a promotion may include a sweepstakes or a giveaway, in which this promotion may be used to promote the location, the kiosk, the web-store, and/or the software application. Furthermore, in one or more embodiments, the kiosk information may then be received back from the consumer, such as through the kiosk and/or the web-store. This may be useful for purposes of providing commissions, such as when tracking or attributing sales or products to a particular kiosk or a particular location, in addition to other purposes.

A method in accordance with the present disclosure may additionally or alternatively include customizing a product. For example, consumer identification information may be received from a consumer, such as a name of the consumer, or a customization desired by the consumer, in which a product may then be customized with this information. In one embodiment, a product may include a stock image or a stock video. Information may be received from the consumer, such as a personal image or personal video, in which the stock image may be customized with the personal image. With respect to the movie industry, this may involve an image of or related to the movie being customized with an image of the consumer, such as by superimposing an image of the consumer within the movie image. In addition to the web-store, in an embodiment in which a software application may be in use, the software application may be used to facilitate this process. For example, the software application may enable a consumer to customize a product. If the product involves an image, the software application may enable the user to customize the image, and then may also enable the user to print, save, download, and/or otherwise output the image or product. This may be controlled for a limited number of outputs as well by the software application or web-store.

Though the present disclosure above discusses a kiosk and/or a location of a kiosk, the present disclosure contemplates embodiments that include multiple kiosks and multiple locations, such as a network of kiosks or locations. As such, a method in accordance with the present disclosure may be performed using multiple kiosks and locations, though the method described above may not be discussed in detail with respect to multiple kiosks or locations. For example, when notifying a consumer of a particular kiosk or location, the consumer need not have been previously associated with that particular kiosk or location. Further, multiple kiosks may be provided at one location, and/or a kiosk may include or be associated with multiple locations, and so a method may be performed using these multiple kiosks and/or multiple locations.

### Example Embodiments and Applications

As discussed above, the present disclosure may relate to developing and deploying a kiosk, and/or may relate to an apparatus, a system, and/or a method of selling products. A kiosk, such as a merchandise or web kiosk, may be provided at one or more locations to interact with or provide consumers with information with respect to each of particular industry. For example, with respect to the movie industry, a kiosk may be developed and/or deployed into one or more theaters and/or one or more chains of theaters. The kiosk may offer links, such as via Q-card, may list website information and/or an options to text a number for access and link information to enter into sweepstakes, as well as for access and link information to the merchandise website (e.g., web-store).

The website and/or the kiosk may be advertised, such as during the preview portion of the movie, and through any other lucrative medium to promote the website and/or the kiosk. Periodic drawings or promotions for valuable prizes and giveaways may be employed to further motivate the consumer to make the initial visit to the website and/or the kiosk. The marketing materials may have a unique link for every theater chain and/or every movie theater, so commissions from sales may be properly tracked and distributed to the correct movie theater. Accordingly, one having ordinary skill in the art will appreciate that, in addition or in alternative to the movie industry, the present disclosure contemplates employing one or more embodiments within one or more other industries.

For example, in the sports industry, a kiosk may be located at a sports arena and/or a gathering for those to view a sports event, whether in-person and/or viewing remotely (such as when viewing a sports event at a watch party), but also applies when viewing a sports event in-person. As such, material may be used to promote the consumer-operated kiosk, such as the location of the kiosk and/or promotions available through the kiosk. Further, materials may also be used to promote the website (e.g., web-store), such as promoting the website through the kiosk and/or promoting the website through the marketing materials or advertisements around, about, and in the vicinity of the location of the kiosk.

Once a consumer (i.e., customer) navigates to the website or web-store, the consumer may be able to shop for exclusive and/or non-exclusive products, such as movie centric products for the movie industry. Additionally, a consumer may be able to customize products through interactive functions, such as by having their image being super-imposed (e.g., in a movie scene and/or over or with a sports figure). Other examples may include having an image super-imposed on a poster and then printed as a custom poster or on a T-shirt. Production of such custom merchandise may be ordered after a bulk sales number is reached, thus allowing the most economy in production may eliminate the need for pre-purchased inventory.

In the movie industry, by way of example, the ultimate goal may be to produce a centralized portal for movie merchandise that is advertised directly in the theaters to reach the most relevant audience during their peak potential to purchase such merchandise. This may allow theaters to receive additional income without having to stock merchandise, and it may eliminate significant loss of space for such quickly out-of-date merchandise, unsold inventory, and the potential of theft.

By offering a web-based location for consumers to purchase movie-based merchandise and products at the time a prospective consumer's peak willingness, right before or after viewing an event or movie, a lucrative yet relatively untapped potential for such sales can be harnessed. These may have exclusive and/or non-exclusive rights, such as by having the opportunity to exclusively sell certain products or opportunities related to the movie.

For example, in addition to other industries, by negotiating exclusive licensing agreements with movie studios, we will be able to offer unique products and opportunities, exclusive memorabilia, and other merchandise. Additionally, in one or more embodiments, we may be able to secure exclusive rights to be the sole merchandise solicitor at the venue/location and/or sole merchandise solicitor with respect to particular merchandise, products, and/or opportunities.

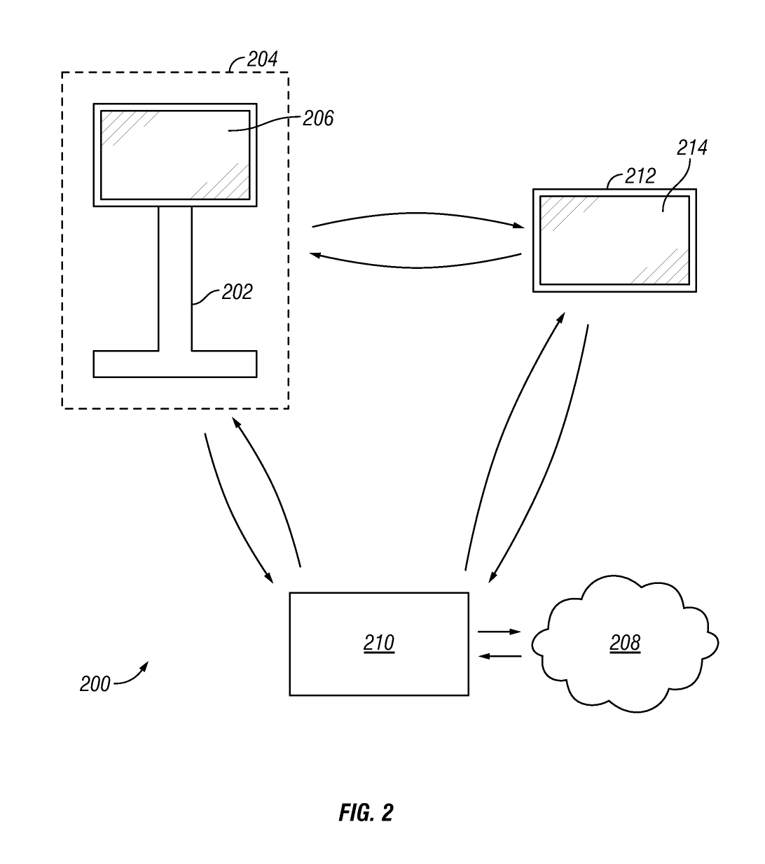

Referring now to FIG. 2, a representative view of a system 200 to sell products in accordance with one or more embodiments of the present disclosure is shown. The system 200 may include one or more of the components shown in FIG. 2, in addition or in alternative to other components not shown in FIG. 2. As such, the system 200 may include a consumer-operated kiosk 202, in which the kiosk 202 may be positioned at a location 204 of interest. Further, as shown, the kiosk 202 may include a user interface 206, if desired, to interact with a user and/or potential consumer.

As discussed, the kiosk 202 may be used to display information related to a web-store 208. Further, the web-store 208 may display information, such as product information, corresponding to products related to the location 204 of the kiosk 202, which may then be available for purchase by a consumer from the web-store 208. In one or more embodiments, the web-store 208 may be accessed in a variety of ways. For example, a computer-based product, such as a server 210, may be used to host and/or serve the web-store 208 to the kiosk 202 and/or an electronic device 212. The electronic device 212 may include a user interface 214 and may be any type of device capable of connecting to the internet and/or displaying the web-store 208. As such, in one or more embodiments, the electronic device 212 may include a personal computer and/or a mobile phone. Thus, the one or more components shown in FIG. 2 may be capable of interacting individually and/or collectively with other components within the system 200.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of selling products, the method comprising:
displaying web-store information related to a web-store on a consumer-operated kiosk at a location; and
displaying product information with the web-store, wherein the product information corresponds to products related to the location of the consumer-operated kiosk and available for purchase by a consumer from the web-store.

2. The method of claim 1, further comprising:
receiving consumer identification information related to the consumer from the consumer-operated kiosk or the web-store; and
associating the consumer identification information with the location of the consumer-operated kiosk.

3. The method of claim 2, further comprising storing the consumer identification information within a database.

4. The method of claim 2, wherein the location of the consumer-operated kiosk comprises a movie theater.

5. The method of claim 4, further comprising associating the consumer identification information with a date and/or a time of a movie.

6. The method of claim 1, further comprising:
receiving consumer identification information related to the consumer from the consumer-operated kiosk or the web-store;
associating the consumer identification information with a discount; and
transmitting the discount to a point-of-sale at the web-store.

7. The method of claim 6, wherein the discount applies to a price of a product related to the product information.

8. The method of claim 1, further comprising:
receiving a consumer selection at the web-store corresponding to at least one of the products;
receiving payment and shipping information at the web-store for the selected product; and
shipping the selected product based upon the received shipping information;
wherein the selected product is not shipped from the location of the consumer-operated kiosk.

9. The method of claim 1, further comprising:
providing consumer-operated kiosk information to a consumer, wherein the kiosk information is related to the location of the consumer-operated kiosk; and
receiving the consumer-operated kiosk information from the consumer using the consumer-operated kiosk or the web-store.

10. The method of claim 1, further comprising:
providing promotional information to the consumer, wherein the promotional information is related to a promotion at the consumer-operated kiosk.

11. The method of claim 1, further comprising:
receiving consumer identification information from a user interface, wherein the consumer identification information associates the user with the location of the consumer-operated kiosk.

12. The method of claim 11, wherein the receiving consumer identification further comprises receiving consumer identification from the user interface associated with at least one of the consumer-operated kiosk and an electronic device of the consumer.

13. The method of claim 1, further comprising reminding the consumer of the web-store information or the product information.

14. The method of claim 1, further comprising:
providing a software application to an electronic device of the consumer; and
receiving consumer identification information related to the consumer using the software application.

15. A method of selling products, the method comprising:
displaying kiosk information related to a consumer-operated kiosk at a location; and
displaying web-store information related to a web-store on the consumer-operated kiosk.

16. The method of claim 15, further comprising displaying product information with the web-store through a website or a software application, wherein the product information corresponds to products related to the location of the consumer-operated kiosk and available for purchase by a consumer from the web-store.

17. The method of claim 16, further comprising:
providing the software application to an electronic device of the consumer; and
receiving consumer identification information related to the consumer through the software application.

18. The method of claim 17, further comprising customizing at least one of the products with the consumer identification information.

19. The method of claim 18, wherein:
the at least one products comprises a stock image;
the consumer identification information comprises a personal image; and
the customizing comprises modifying at least a portion of the stock image with at least a portion of the personal image.

20. The method of claim 19, wherein the stock image comprises a stock video, and wherein the personal image comprises a personal video.

21. The method of claim 17, further comprising sending a notification to the software application of the electronic device when the electronic device is within a predetermined area of the consumer-operated kiosk or another consumer-operated kiosk.

22. The method of claim 21, wherein the notification comprises information related to the web-store, the location of the consumer-operated kiosk, or a location of the other consumer-operated kiosk.

23. The method of claim 17, wherein the electronic device comprises a mobile device and/or a personal computer.

24. A system for selling products at a location, the system comprising:
a consumer-operated kiosk to be located at the location, the consumer-operated kiosk comprising web-store information related to a web-store; and
a server to host the web-store, the web-store displaying product information with the product information corresponding to products related to the location of the consumer-operated kiosk and available for purchase by a consumer at a point-of-sale at the web-store.

25. An apparatus for selling products at a location, the apparatus comprising:
a consumer-operated kiosk to be located at the location;
the consumer-operated kiosk comprising web-store information related to a web-store such that the web-store displays product information corresponding to products related to the location of the consumer-operated kiosk.
